(19) United States
(12) Patent Application Publication
(10) Pub. No.: US 2011/0095050 A1
(43) Pub. Date: Apr. 28, 2011

(54) DISPENSER

(76) Inventor: HANS GEORG HAGLEITNER, ZELL AM SEE (AT)

(21) Appl. No.: 12/940,280

(22) Filed: Nov. 5, 2010

Related U.S. Application Data
(63) Continuation of application No. PCT/AT2009/000141, filed on Apr. 8, 2009.

(30) Foreign Application Priority Data
May 5, 2008 (AT) A 699/2008

(51) Int. Cl. B67D 3/00

(52) U.S. Cl. 222/25

(57) ABSTRACT

An electrically operated dispenser for sanitary or hygienic products, for example soap, paper, cleaning or care products or the like, contains a housing and respective displays which are visible from the exterior and which indicate operability and a required service intervention. At least one third display is provided in the interior of the dispenser and indicates the type of service intervention required once the housing has been opened.

### CROSS-REFERENCE TO RELATED APPLICATION

This is a continuation application, under 35 U.S.C. § 120, of copending international application No. PCT/AT2009/000141, filed Apr. 8, 2009, which designated the United States; this application also claims the priority, under 35 U.S.C. § 119, of Austrian patent application No. A 699/2008, filed May 5, 2008; the prior applications are herewith incorporated by reference in their entirety.

### BACKGROUND OF THE INVENTION

### Field of the Invention

The invention relates to an electrically operated dispenser for sanitary or hygiene products, for example soap, paper, cleaning or care products or the like, having a housing and having a respective indicator, which is visible from the outside, for readiness for operation and for a required service intervention. A dispenser of this kind, which is used, in particular, to dispense a fluid, such as soap or disinfectant, is described in international patent disclosure WO 2004/086731, corresponding to U.S. Pat. No. 7,611,030, for example. A plurality of light-emitting diodes (LEDs) are visible on the front face of the housing, the LEDs indicating to the user where he has to position his hands in order for the fluid to be dispensed, and the LEDs further indicating a low charge state of the replaceable power source and a low filling level of the medium. These indicators, which are directed at the service personnel, are of different colors, for example yellow or red, in contrast to the indicator for the user, which indicator is, for example, green.

### SUMMARY OF THE INVENTION

It is accordingly an object of the invention to provide a dispenser which overcomes the above-mentioned disadvantages of the prior art devices of this general type.

With the foregoing and other objects in view there is provided, in accordance with the invention an electrically operated dispenser for sanitary products or hygiene products, including soap, paper, cleaning or care products. The electically operated dispenser contains a housing, first and second indicators disposed on the housing and visible from an outside indicating readiness for operation and a required service intervention, and at least a third indicator disposed in an interior of the housing dispenser and indicating a type of service intervention needed and is evident after the housing is opened.

For the purpose of providing an indication which is as unmistakable as possible both for the user and for the service personnel, the invention proposes providing at least a third indicator in the interior of the dispenser, and the type of service intervention being evident after the housing is opened. Therefore, only one indicator for readiness for operation and one indicator for a service intervention are visible on the outer face, but the type of the service intervention is not visible. It is irrelevant to the user whether the product reservoir is running low or whether the battery charge state is low, and therefore the detailed information is not shown to the user and is first shown to the service personnel when the dispenser is opened, the dispenser having to be opened in order to perform the service measure in any case. The indication, which is visible from the outside on the front, for a required service intervention is provided preferably in good time before an interruption in operation owing to a lack of product or a power failure, and the readiness for operation of the dispenser remains unchanged and is also indicated over this period of time. However, the indication for a service intervention can also be simplified by a, for example flashing, indicator for the readiness for operation no longer lighting up and therefore changing from an active first indicator to a passive second indicator. In the same way, the indicator for readiness for operation could be passive and only become active as an indicator for a fault.

If the dispenser is opened by the service personnel, the type of the third indicator will be shown, with at least one active, but also one passive indicator, also being possible here. If, for example, only battery exchange or refilling is to be indicated, a single active third indicator, for example for battery exchange, is sufficient since, given an external indicator, the lack of an active indicator in the interior likewise constitutes an item of information, specifically as a passive indicator, indicating that a product needs to be refilled, this already being indicated, for example in the case of paper dispensers, by the lack of the roll. A third, active indicator can be provided in the region of the service measure, in particular when more than one active, third indicator is present. Therefore, for example, an indicator for the exchange of batteries is particularly significant when it is arranged at or near a battery compartment. In this case, a third, active indicator for the replacement of a container, for example a soap container, would be provided on or near the container receptacle, and a third, active indicator for refilling paper would be provided on or near the insertion point for a reserve roll . In the case of dispensers with an incorporated power source in particular, the indicator for readiness for operation is preferably formed by an LED which flashes green and the indicator for the required service intervention is preferably formed by an LED which flashes red. The third, active indicator in the interior can likewise be formed by a flashing or else permanently lit LED, particularly when it is first activated by the housing being opened.

Other features which are considered as characteristic for the invention are set forth in the appended claims.

Although the invention is illustrated and described herein as embodied in a dispenser, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, front exterior view of a dispenser according to the invention;

FIG. 2 is a diagrammatic, front/side perspective view of an open soap dispenser; and

FIG. 3 is a diagrammatic, front view of an open paper dispenser.

### DETAILED DESCRIPTION OF THE INVENTION

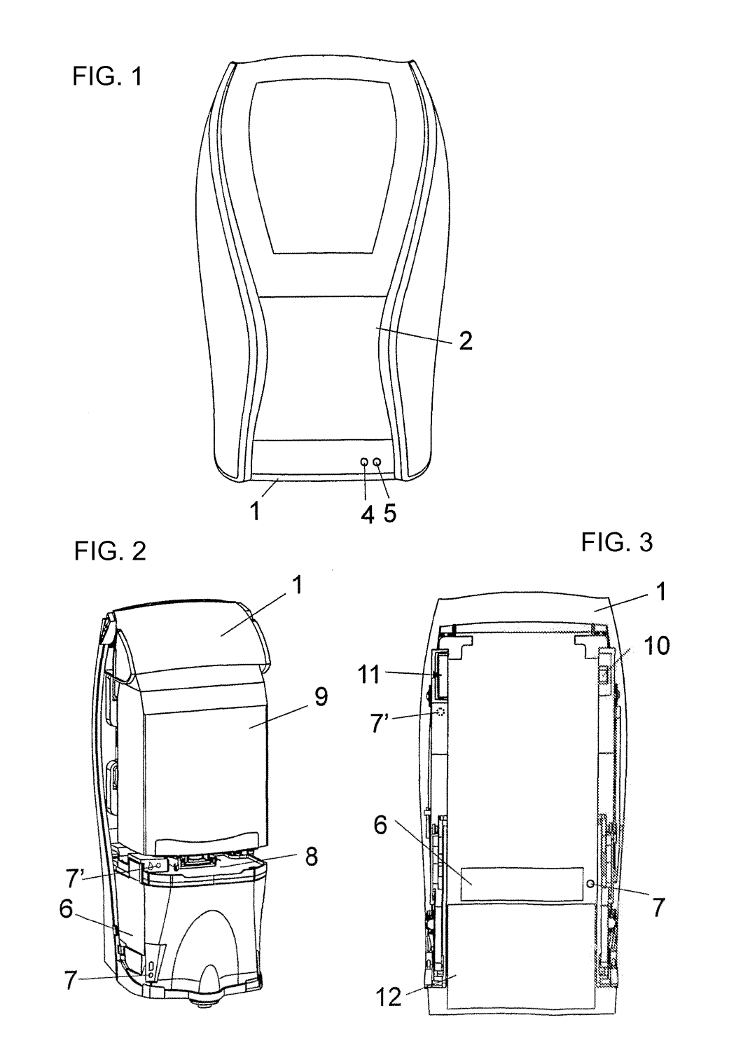

Referring now to the figures of the drawing in detail and first, particularly, to FIG. 1 thereof, there is shown an electrically operated dispenser that has a housing 1, which, in particular, can be fitted on a wall and is provided with a cover 2 which can be opened. An indicator 4, which is visible from the outside, for readiness for operation and an indicator 5, which is visible from the outside, for the need for a service intervention (soon) are provided anywhere on the housing 1 or on the cover 2 in locations which are clearly visible, for example, as shown in FIG. 1, in the region of the lower right-hand corner of the cover 2. In the case of dispensers with an internal power source (batteries) in particular, the indicator 4 for readiness for operation is formed by a power-saving flashing, in particular green, light-emitting diode (LED). The indicator 5 for the need for a service intervention (soon) is preferably likewise formed by an LED which, in particular, flashes red. Since the indication for the service intervention being due is produced preferably a sufficiently long time before operation is interrupted, the indicator 4 for readiness for operation is likewise still functioning and the indicator 5 then preferably flashes in the flashing intervals of the indicator 4. Therefore, as an alternative, it is also feasible to combine the two indicators 4, 5 beneath one cover or, in another embodiment, to allow both indicators 4, 5 to flash at the same time. The type of service intervention is not of interest to the user and therefore only the need for a service intervention is indicated on the outside. For the service personnel, the indicator 5 means that the cover 2 has to be opened, and details about the type of service intervention are evident in the interior.

In order to indicate the need to replace a battery, a third indicator 7 is preferably provided in the region 6 of the battery compartment or battery cover, it being possible for the third indicator to likewise contain a red LED which flashes or lights up when a battery needs to be replaced.

If a product has to be refilled, for example a new container 9 containing soap or another fluid (FIG. 2) or a new reserve roll (FIG. 3) has to be refilled, there is no need for an additional indicator in the interior when there is no alternative and exchange of a battery can be ruled out, that is to say when the third, active indicator 7 does not flash or light up. However, it is, of course, possible to also provide an active third indicator 7′ in the respective region 11 for the product refill operation, for example on the container receptacle 8 in the case of the soap dispenser according to FIG. 2, or at the insert opening 10 for the reserve roll in the case of the paper dispenser according to FIG. 3. The third indicators 7′ are only indicated by dashed lines since, as mentioned, they are not compulsory.

In FIG. 2, an intermediate chamber is preferably provided in the container receptacle 8, the intermediate chamber containing a filling level sensor. If the filling level sensor indicates a lack of fluid, it activates the external indicator 5 for the service intervention. Furthermore, fluid can be dispensed as long as there is residual fluid in the intermediate chamber. In FIG. 3, numeral 12 denotes the roll which is being used and from which paper is dispensed, and the reserve roll to be inserted slides down into the position of the roll when the roll 12 which is being used is empty; this then triggers the indicator 5 for the service intervention on the outside.

The table below provides an overview of the three indicators in a preferred exemplary embodiment.

| | Status | | |
|---|---|---|---|
| | 1st indicator, | 2nd indicator, | Indicator, |
| | external | external | internal |
| | green | red | red |
| Operation | Flashes for 20 | X | X |
| | ms every 4 secs | | |
| Identification of | Lights up | X | X |
| product being | | | |
| dispensed | | | |
| Operation, refilling | Flashes for 20 | 150 ms delay, | X |
| required | ms every 4 secs | flashes for 20 | |
| | | ms every 4 secs | |
| No product | X | Flashes for 500 | X |
| | | ms every second | |
| Battery empty | X | Flashes for 500 | Lights up |
| | | ms every second | |

1. An electrically operated dispenser for sanitary products or hygiene products, including soap, paper, cleaning or care products, the electically operated dispenser comprising:
a housing;
first and second indicators disposed on said housing and visible from an outside indicating readiness for operation and a required service intervention; and
at least a third indicator disposed in an interior of said housing dispenser and indicating a type of service intervention needed and is evident after said housing is opened.

2. The dispenser according to claim 1, wherein said second indicator, which is visible from the outside, indicating a required service intervention is activated before operation of the dispenser is interrupted.

3. The dispenser according to claim 1, wherein said third indicator is formed in a region of a replaceable power source.

4. The dispenser according to claim 1, wherein said third indicator is formed in a region of a product refill.

5. The dispenser according to claim 2, wherein said first, second and third indicators are colored lamp elements.

6. The dispenser according to claim 5, wherein said first indicator, which is visible from the outside, is provided for indicating readiness for operation and is formed by an LED which flashes green.

7. The dispenser according to claim 5, wherein said second indicator, which is visible from the outside, and indicates the required service intervention is formed by an LED which flashes red.

8. The dispenser according to claim 6, wherein said second indicator, which is visible from the outside, and indicates the required service intervention is evident in each case from a flashing interval of said first indicator for readiness for operation.

9. The dispenser according to claim 1, wherein said third indicator is first activated by said housing being opened.

10. The dispenser according to claim 1, wherein said third indicator for indicating the type of service intervention can be actuated in dependence on a detected charge state of a replaceable power source and/or in dependence on a detected filling level of the product.
